(19) United States
(12) Patent Application Publication
(10) Pub. No.: US 2006/0185922 A1
(43) Pub. Date: Aug. 24, 2006

(54) Obstacle discrimination device for vehicle

(75) Inventor: Takatoshi Tanabe, Ichinomiya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/351,500

(22) Filed: Feb. 10, 2006

(30) Foreign Application Priority Data
Feb. 23, 2005 (JP) 2005-047465

(51) Int. Cl. B60K 28/10

(52) U.S. Cl. 180/274; 180/271

(57) ABSTRACT

An obstacle discrimination device for a vehicle has an upper bumper absorber, a lower bumper absorber, a load detection unit and a control unit for sort-discriminating an obstacle based on a load detected by the load detection unit. The upper bumper absorber is connected with side members of the vehicle through the load detection unit, while the lower bumper absorber is connected with the side members without through the load detection unit. Thus, the difference between the detected load in the case of the collision with a human and that in the case of the collision with an object fixed on the ground becomes large. Accordingly, the human can be satisfactorily discriminated from the object fixed on the ground.

### CROSS REFERENCE TO RELATED APPLICATION

This application is based on a Japanese Patent Application No. 2005-47465 filed on Feb. 23, 2005, the disclosure of which is incorporated herein by reference.

### FIELD OF THE INVENTION

The present invention relates to an obstacle discrimination device for sort-distinguishing an obstacle colliding with a vehicle. The obstacle discrimination device is suitably used to discriminate whether or not the obstacle is a human, for example, a pedestrian.

### BACKGROUND OF THE INVENTION

A collision load due to a collision of a vehicle is detected, for example, referring to US2004/0129479A1, by measuring a tension variation of a wire due to the collision. The wire having a predetermined initial tension is transversely stretched along the front surface of a bumper reinforce member of the vehicle.

Referring to JP-2004-156945A, a pair of conducting wires which are parallel to each other are transversely arranged at the vehicle front portion, and will contact each other due to the collision of the vehicle. Thus, the collision of the vehicle can be detected according to whether or not the conducting wires contact each other.

Referring to JP-7-190732A, a light emitting unit and a light receiving unit are respectively disposed at two ends of a light leakage fiber which is transversely arranged at the front bumper of the vehicle. The light leakage fiber will be deformed or broken due to the collision of the vehicle so that the light receiving amount of the light receiving unit is reduced. Thus, the collision is detected.

Moreover, various pedestrian protection devices are proposed responding to the desire that a pedestrian is to be protected from the collision with the vehicle. When the pedestrian protection device is actuated in the case where the obstacle is not the pedestrian, adverse influences will be caused. Therefore, it is desired to discriminate the pedestrian from other obstacles colliding with the vehicle. Referring to JP-11-028994A, the pedestrian is distinguished based on the time duration of the collision load which exceeds a predetermined value.

Furthermore, referring to US6561301B1, the pedestrian is distinguished according to the increase rate of the collision load after the collision load exceeds a predetermined value.

Besides, it is also proposed that the pedestrian is distinguished based on the peak value of the collision load.

As described above, in general, the vehicle is provided with a collision load detection sensor. The pedestrian is distinguished according to whether or not the detected waveform (including magnitude) of the collision load is within a predetermined range, which includes the collision load waveform in the case where the pedestrian collides with the vehicle. That is, the pedestrian is distinguished according to whether or not the collision load waveform is similar to that due to the collision between the pedestrian and the vehicle.

However, for example, poles (i.e., road-side markers) or the like are fixed on the ground and dotted with a substantially even distance therebetween to indicate a road-side boundary so as to inform a road shoulder, in the areas (e.g., Europe and Japan) where snow accumulation is much. Thus, in the case where the vehicle collides with the obstacle (e.g., road-side markers) fixed on the ground due to an error driving or the like, it is possible that a collision load which is substantially equal to that due to the collision between the vehicle and the pedestrian is applied to the vehicle. Therefore, in this case, it is difficult to discriminate whether or not the obstacle is the pedestrian based on the collision load detected by the collision load detection sensor.

### SUMMARY OF THE INVENTION

In view of the above-described disadvantage, it is an object of the present invention to provide an obstacle discrimination device for a vehicle, through which a human (e.g., pedestrian) can be substantially distinguished, especially from an obstacle (e.g., erection object) fixed on the ground.

According to the present invention, an obstacle discrimination device for a vehicle is provided with an upper bumper absorber which is arranged at an upper portion in a bumper of the vehicle to absorb collision energy, a lower bumper absorber which is arranged at a lower portion in the bumper to absorb collision energy, a plurality of load detection units for detecting a load exerted to the vehicle due to a collision between an obstacle and the bumper, and a control unit for sort-discriminating the obstacle which collides with the bumper based on the load detected by the load detection units. The upper bumper absorber is connected with a first support unit of the vehicle through the load detection units. The lower bumper absorber is connected with one of the first support unit and a second support unit of the vehicle without through the load detection units. The second support unit is different from the first support unit.

In this case, the upper bumper absorber is connected with the first support unit through the load detection units, while the lower bumper absorber which is disposed at the lower side of the upper bumper absorber in the bumper is connected with the first support unit or the second support unit without through the load detection units. Thus, the load exerted to the upper bumper absorber due to the collision between the obstacle and the bumper is transmitted to the load detection units, while the load exerted to the lower bumper absorber is not transmitted to the load detection units.

Therefore, the detected load with respect to the vehicle-human collision where the ratio of the load exerted to the upper bumper absorber to that exerted to the lower bumper absorber is relatively large, becomes much larger than the detected load with respect to the vehicle-stationary collision where the ratio of the load exerted to the upper bumper absorber to that exerted to the lower bumper absorber is relatively small. The vehicle-human collision means a collision between the vehicle and the human, and the vehicle-stationary collision means a collision between the vehicle and the obstacle fixed on the ground, for example, the erection object such as the road-side marker and a post cone.

That is, the difference between the detected load in the vehicle-human collision and that in the vehicle-stationary collision becomes large. Accordingly, the human (e.g., pedestrian) can be satisfactorily discriminated from the obstacle (e.g., erection object) fixed on the ground.

Preferably, at least a part of the lower bumper absorber is disposed at a vehicle front side of the upper bumper absorber.

Thus, the difference between the detected load in the vehicle-human collision and that in the vehicle-stationary collision becomes further large. Accordingly, the discrimination of the obstacle colliding with the vehicle can be further improved.

### BRIEF DESCRIPTION OF THE DRAWINGS

Other objects, features and advantages of the present invention will become more apparent from the following detailed description made with reference to the accompanying drawings, in which:

FIG. 1 is a block diagram showing a whole construction of an obstacle discrimination device for a vehicle according to a preferred embodiment of the present invention;

FIG. 2 is a schematic plan view showing a vicinity of a bumper of the vehicle according the preferred embodiment;

FIG. 3 is a schematic side view showing the vicinity of the bumper according the preferred embodiment;

FIG. 4A is a graph showing load variations with time in the case where a human collides with the bumper, and FIG. 4B is a graph showing load variations with time in the case where a road-side marker collides with the bumper;

FIG. 5 is a schematic side view showing a vicinity of a bumper of a vehicle according to a comparison example;

FIG. 6A is a graph showing a difference A between a detected load in the case of the collision between the vehicle and the human and that in the case of the collision between the vehicle and the road-side marker according to the preferred embodiment, and FIG. 6B is a graph showing a difference B between a detected load in the case of the collision between the vehicle and the human and that in the case of the collision between the vehicle and the road-side marker according to the comparison example;

FIG. 7 is a schematic side view showing a vicinity of a bumper of a vehicle according to other embodiment of the present invention;

FIG. 8 is a graph showing load variations with time in the case where a road-side marker collides with the bumper according to the other embodiment and those according to the preferred embodiment; and

FIG. 9 is a graph showing a difference A′ between a detected load in a collision between the vehicle and a human and that in a collision between the vehicle and the road-side marker according to the other embodiment, and the difference A according to the preferred embodiment.

### DETAILED DESCRIPTION OF THE PREFERRED EMBODIMENT

### Preferred Embodiment

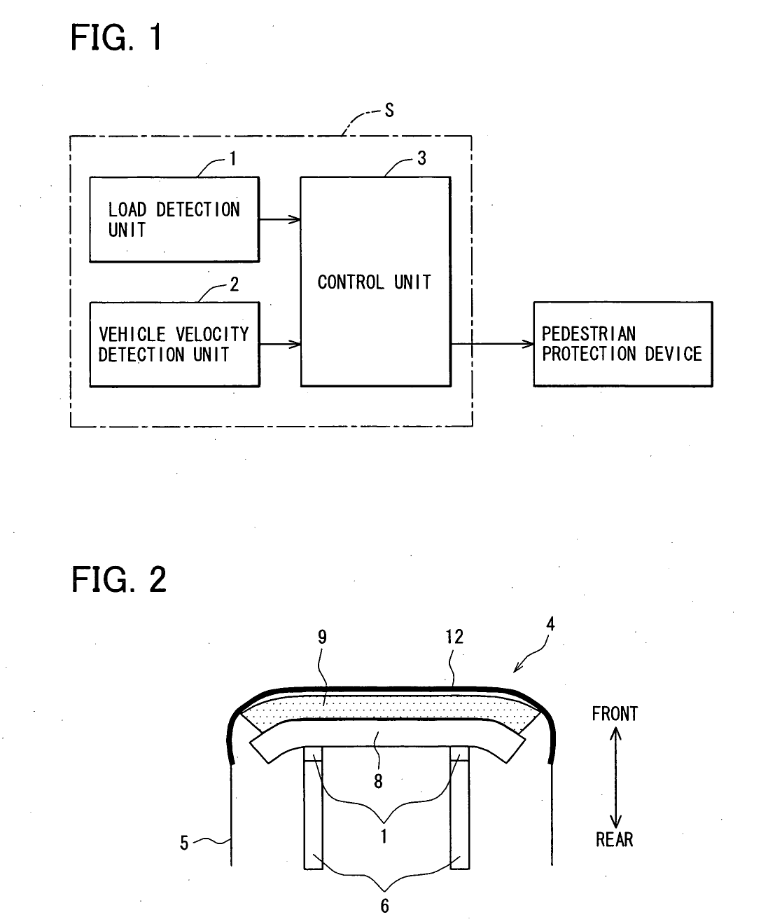

According to a preferred embodiment of the present invention, referring to FIG. 1, an obstacle discrimination device S is mainly provided with a load detection unit 1, a vehicle velocity detection unit 2, and a control unit 3 (obstacle discrimination circuit) which is connected with, for example, a pedestrian protection device through a signal wire or the like. The load detection unit 1 is constructed of a plurality of load sensors, for example. The vehicle velocity detection unit 2 is constructed of at least one, for example, velocity sensor.

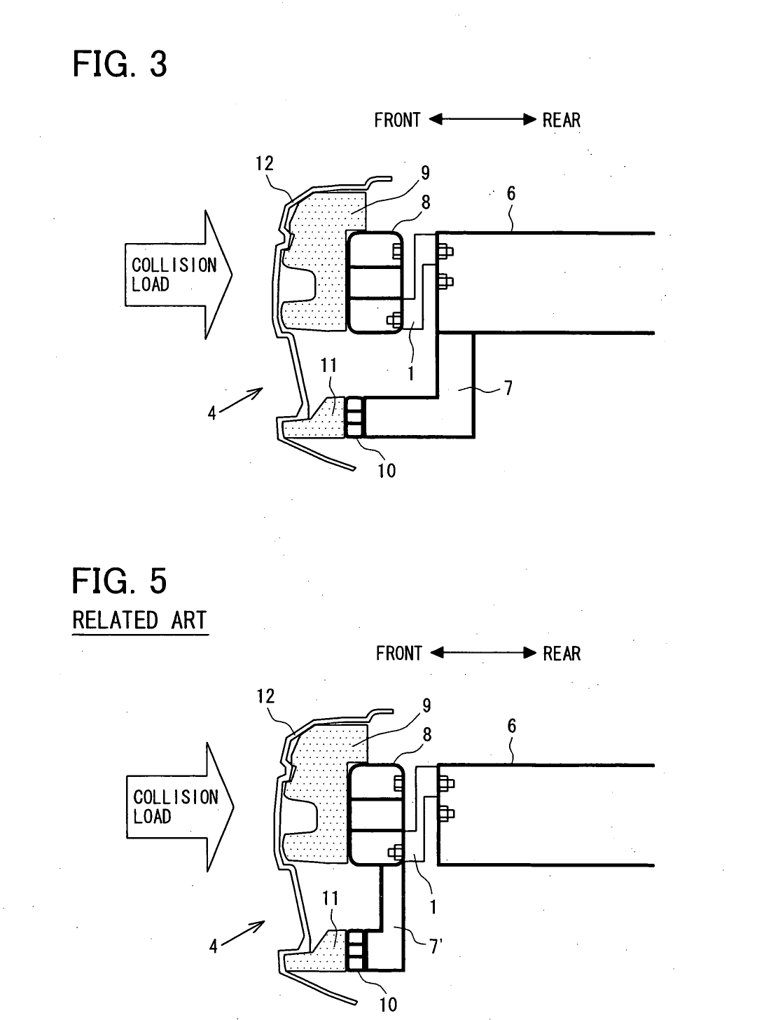

As shown in FIGS. 2 and 3, the vehicle has two side members 6, which extend in a vehicle front-rear direction (vehicle longitudinal direction) in a vehicle body 5 and are respectively disposed at a left portion and a right portion of the vehicle. The right portion and the left portion of the vehicle are defined with respect to a vehicle width direction (i.e., vehicle left-right direction). The two side members 6 construct a first support unit in the present invention.

In this embodiment, the two load sensors 1 (e.g., strain-typed load sensors) are sandwiched respectively between a rear end surface of an upper bumper reinforce member 8 and front end surfaces of the side members 6. That is, the two load sensors 1 are respectively disposed at the right portion and the left portion of the vehicle. The upper bumper reinforce member 8, being a vehicle construction member, extends in the vehicle width direction.

A bumper 4 of the vehicle is constructed of an upper bumper absorber 9, an lower bumper absorber 11 and a bumper cover 12, which covers the upper bumper reinforce member 8, the upper bumper absorber 9 and the lower bumper absorber 11. Each of the upper bumper absorber 9 and the lower bumper absorber 11 extends in the vehicle width direction, and is constructed of a resilient body such as a foam resin to absorb collision energy.

The upper bumper absorber 9 is arranged at the upper portion in the bumper cover 12 and disposed at the vehicle front side of the upper bumper reinforce member 8. The lower bumper absorber 11 is arranged at the lower portion in the bumper cover 12 and disposed at the vehicle front side of a lower bumper reinforce member 10. The lower bumper absorber 11 is supported by the lower bumper reinforce member 10. In this embodiment, the vehicle-longitudinal-direction arrangements of the upper bumper absorber 9 and the lower bumper absorber 11 are set substantially same with each other.

The lower bumper reinforce member 10, being a vehicle construction member extending in the vehicle width direction, is mounted to front end surfaces of two brackets 7 of the vehicle body 5 and disposed at the vehicle lower side of the upper bumper reinforce member 8. The brackets 7 respectively extend from the lower surfaces of the two side members 6 toward the vehicle lower side and the vehicle front side.

In this case, the upper bumper absorber 9 is indirectly connected with the side members 6 at the upper portion in the bumper cover 12, through the load sensors 1. For example, the upper bumper absorber 9 can be connected with the side members 6 through the load sensors 1 and the upper bumper reinforce member 8. The lower bumper absorber 11 is indirectly connected with the side members 6 at the lower portion in the bumper cover 12, without through the load sensors 1. For example, the lower bumper absorber 11 can be connected with the side members 6 through the brackets 7 and the lower bumper reinforce member 10.

Referring to FIG. 3, each of the strain-typed load sensors 1 is constructed of a strain gauge (not shown) which is bonded (applied) to a surface of a metal plate member having a crank-shaped longitudinal cross section. The upper portion of the strain-typed load sensor 1 which has the crank-shaped longitudinal cross section is provided with a screw portion extending toward the vehicle rear side, for example.

The screw portions of the strain-typed load sensors 1 are respectively inserted through holes arranged at the substantial central portions of the front end surfaces of the side members 6, to be fastened to the front end surfaces through nuts or the like. Similarly, the lower portions of the strain-typed load sensors 1 are fastened to the lower portion of the rear end surface of the upper bumper reinforce member 8.

The longitudinal central portion of the strain-typed load sensor 1 is substantially vertically positioned, and separated from the upper bumper reinforce member 8 and the side members 6.

The control unit 3 can be constructed of a signal process circuit in which a microprocessor is embedded, to discriminate whether or not an obstacle colliding with the vehicle is a human (e.g., pedestrian) based on output signals from the load sensors 1 (or based on output signals from load sensors 1 and those from vehicle velocity sensor 2). When it is determined that the obstacle is the pedestrian, the pedestrian protection device (e.g., pedestrian-protecting airbag and hood raising device) and the like will be actuated.

Next, the obstacle discrimination process of the obstacle discrimination device S will be described.

When an obstacle collides with the bumper 4 of the vehicle, each of the load sensors 1 will output collision load signals to the control unit 3. The collision load signals respectively from the two load sensors 1 are added up, for a calculation of a total collision load which is exerted to the vehicle from the front side thereof.

Then, it is judged whether or not the total collision load is equivalent to that due to a collision (vehicle-human collision) between the vehicle and a human (e.g., pedestrian). When the total collision load is equivalent to that due to the vehicle-human collision, it is determined that the obstacle is the human. Thus, the pedestrian protection device is actuated based on an output signal from the control unit 3.

On the other hand, in the case where the total collision load is not equivalent to that due to the vehicle-human collision, it is determined that the obstacle is not the human. In this case, the pedestrian protection device will not be actuated.

Alternatively, the obstacle colliding with the vehicle can be also sort-discriminated based on the mass thereof. In this case, the total collision load detected by the load sensors 1 and the vehicle velocity detected by the vehicle velocity sensor 2 are input to the control unit 3 and substituted into a beforehand-memorized map. Thus, the mass of the obstacle can be calculated. In this case, the calculated mass of the obstacle is a value of the total collision load which is divided by the variation rate of the vehicle velocity.

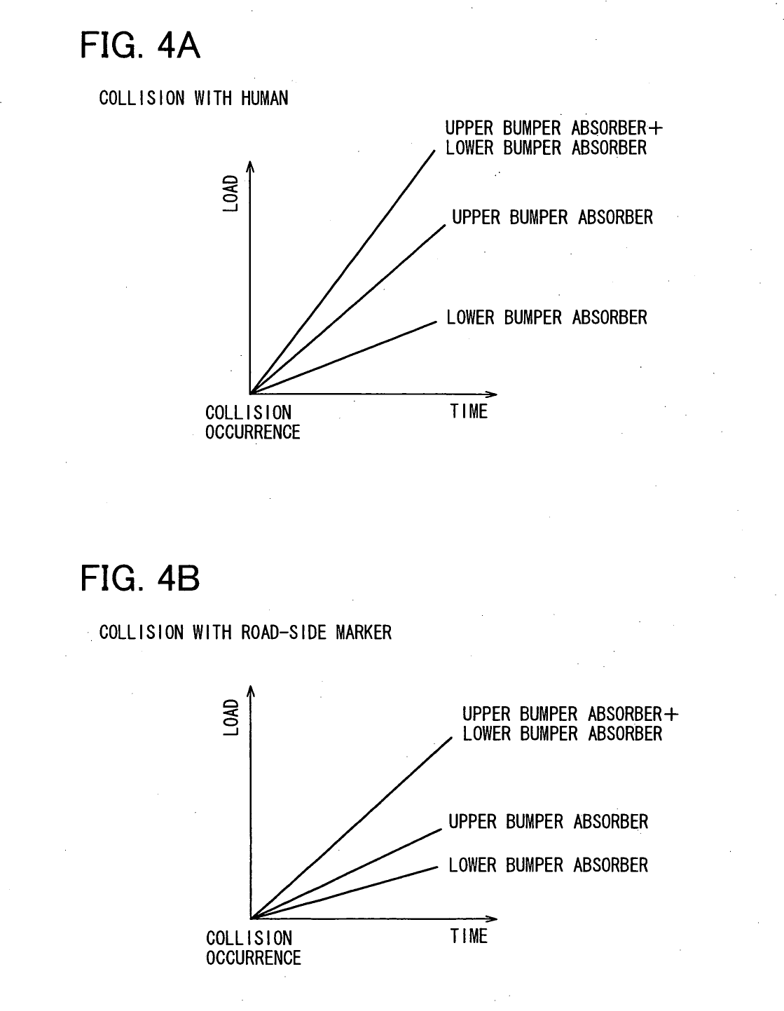

According to the obstacle discrimination device S of the present invention, the human can be substantially discriminated from other obstacles, especially from the object (e.g., road-side marker) fixed on the ground. FIGS. 4A and 4B show the time variations (that is, variations with time after collision occurs) of the load exerted to the upper bumper absorber 9, the load exerted to the lower bumper absorber 11, and the total load exerted to the upper bumper absorber 9 and the lower bumper absorber 11. FIG. 4A shows the case where the vehicle (bumper 4) collides with the human. FIG. 4B shows the case where the vehicle (bumper 4) collides with the road-side marker.

Referring to, FIG. 4A and FIG. 4B, the total load exerted to the upper bumper absorber 9 and the lower bumper absorber 11 due to the collision between the vehicle and the human is larger than that due to the collision between the vehicle and the road-side marker.

Moreover, the ratio of the load exerted to the upper bumper absorber 9 to that exerted to the lower bumper absorber 11 due to the collision between the vehicle and the human is larger than that due to the collision between the vehicle and the road-side marker.

In the case where the human collides with the vehicle, the foot portion of the human is hit by the bumper 4 and the human body is raised so that the load exerted to the lower portion of the bumper 4 becomes relatively small. Therefore, the ratio of the load exerted to the upper bumper absorber 9 to that exerted to the lower bumper absorber 11 is relatively large.

On the other hand, in the case where the vehicle collides with the object (e.g., road-side marker) fixed on the ground, the object is fixed on the ground so that the load exerted to the lower portion of the bumper 4 becomes relatively large. Therefore, in this case, the ratio of the load exerted to the upper bumper absorber 9 to that exerted to the lower bumper absorber 11 is relatively small.

A comparison example is shown in FIG. 5. In this case, the lower bumper absorber 11 is supported by the lower bumper reinforce member 10 and a bracket 7′ which downward extends from the rear surface of the upper bumper reinforce member 8. The upper bumper reinforce member 8 is connected with the load sensor 1. Thus, both the load exerted to the upper bumper absorber 9 and that exerted to the lower bumper absorbed 11 are transmitted to the load sensors 1 through the upper bumper reinforce member 8, to be detected.

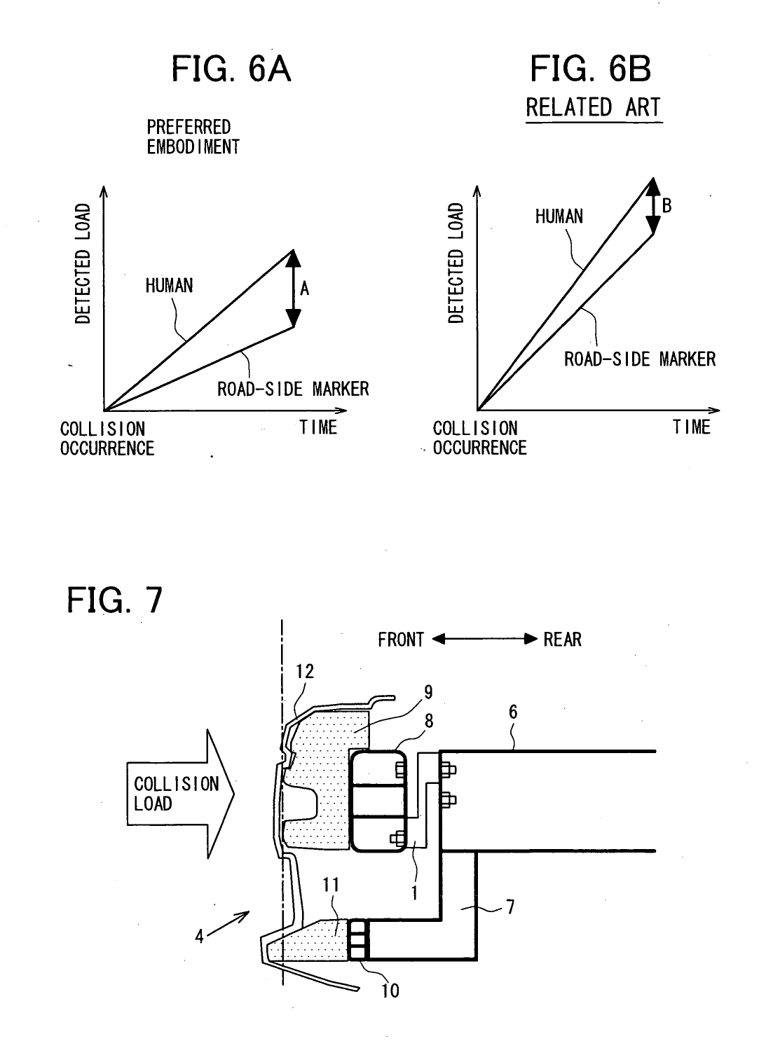

FIG. 6A shows the time variations (variations with time after collision occurs) of the detected load in the case of the collision between the human and the vehicle and that in the case of the collision between the vehicle and the road-side marker, according to the preferred embodiment. FIG. 6B shows the time variations (variations with time after collision occurs) of the detected load in the case of the collision between the human and the vehicle and that in the case of the collision between the vehicle and the road-side marker, according to the comparison example. The detected load is the total collision load detected by the load sensors 1.

Referring to FIGS. 6A and 6B, the difference A between the detected loads (respectively in the cases of collision with human and collision with road-side marker) after the time T passed from the occurrence of the collision according to the preferred embodiment, is larger than the difference B between those according to the comparison example.

According to the preferred embodiment, only the load exerted to the upper bumper absorber 9 is transmitted to the load sensors 1 to be detected, while the load exerted to the lower bumper absorber 11 is not transmitted to the load sensors 1. That is, the load which is exerted to the lower portion (corresponding to lower bumper absorber 11) of the bumper 4 is not detected by the load sensors 1. As described above, the ratio of the load exerted to the upper bumper absorber 9 to that exerted to the lower bumper absorber 11 due to the collision between the vehicle and the human is larger than that due to the collision between the vehicle and the road-side marker.

As shown in FIGS. 6A and 6B, the detected load in the case of the collision between the vehicle and the human is larger than that in the case of the collision between the vehicle and the road-side marker. Because the load exerted to the lower portion of the bumper 4 due to the collision with human is relatively small, the difference A between the detected load in the case of the collision with the human and the detected load in the case of the collision with the road-side marker according to the preferred embodiment is larger than the difference B between those according to the comparison example.

Therefore, the discrimination accuracy of the obstacle according to the preferred embodiment can be improved with respect to the comparison example.

As described above, according to the obstacle discrimination device S of the preferred embodiment, the upper bumper absorber 9 is connected with the side members 6 through the upper bumper reinforce member 8 and the load sensors 1. The lower bumper absorber 11 is connected with the side members 6 without through the load sensors 1.

The detected load in the case of the vehicle-human collision where the ratio of the load exerted to the upper bumper absorber 9 to that exerted to the lower bumper absorber 11 is relatively large, becomes much larger than the detected load in the case of the vehicle-stationary collision, where the ratio of the load exerted to the upper bumper absorber 9 to that exerted to the lower bumper absorber 11 is relatively small. The vehicle-stationary collision means the collision between the vehicle and the object fixed on the ground, for example, the erection object such as the road-side marker and a post cone.

That is, the difference between the detected load in the case of the vehicle-human collision and that in the case of the vehicle-stationary collision becomes large. Accordingly, the human (e.g., pedestrian) can be satisfactorily discriminated from the object (e.g., erection object) fixed on the ground.

### Other Embodiment

Although the present invention has been fully described in connection with the preferred embodiments thereof with reference to the accompanying drawings, it is to be noted that various changes and modifications will become apparent to those skilled in the art.

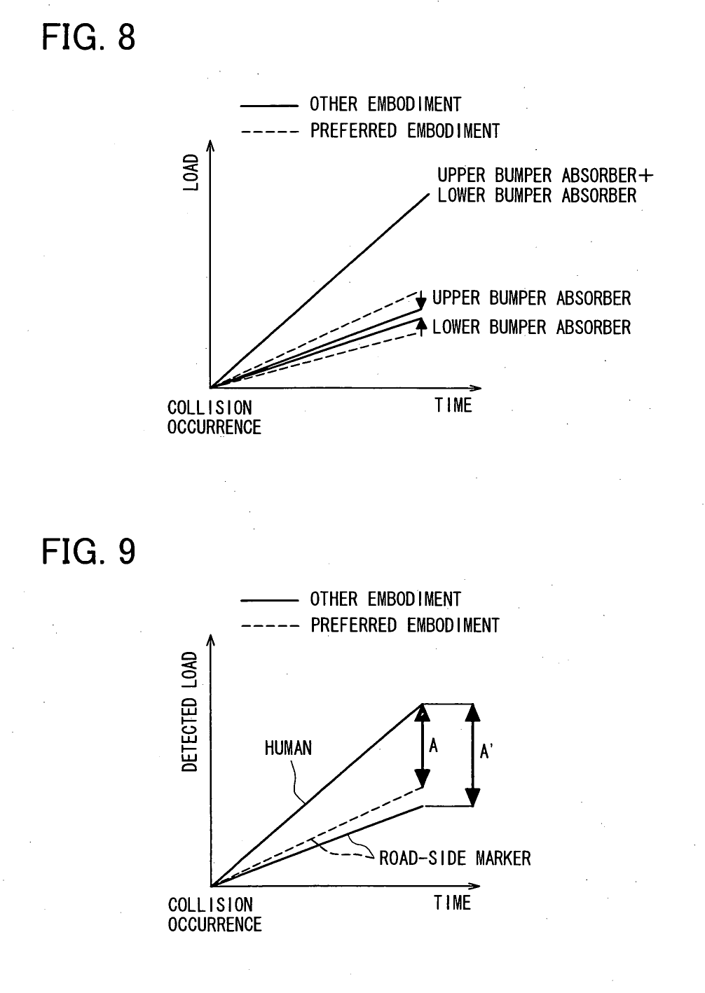

In the above-described preferred embodiment, the vehicle-longitudinal-direction arrangements of the upper bumper absorber 9 and the lower bumper absorber 11 are set substantially same with each other. However, referring to FIG. 7, at least a part of the lower bumper absorber 11 can be also arranged at the vehicle front side of the upper bumper absorber 9. FIG. 8 shows the time variations (variations with time after collision occurs) of the load exerted to the lower bumper absorber 11 and that exerted at the upper bumper absorber 9 due to the collision between the vehicle (bumper 4) and the road-side marker, according to the other embodiment (indicated by solid line) and the preferred embodiment (indicated by dotted line). Moreover, FIG. 8 shows the time variation (variations with time after collision occurs) of the total load exerted to the lower bumper absorber 11 and the upper bumper absorber 9 due to the collision between the vehicle (bumper 4) and the road-side marker according to the other embodiment.

According to the other embodiment, in the case of the vehicle-stationary collision, the load exerted to the lower bumper absorber 11 is increased while the load exerted to the upper bumper absorber 9 is deceased as compared with the preferred embodiment, as shown FIG. 8. That is, according to the other embodiment, the ratio of the load exerted to the upper bumper absorber 9 to that exerted to the lower bumper absorber 11 becomes small in the case where the bumper 4 collides with the road-side marker.

Therefore, as shown in FIG. 9, the differences A′ (after time T passed from collision occurrence) between the detected load in the case of the collision with the human and that in the case of the collision with the road-side marker according to the other embodiment (indicated by solid line), is larger than the difference A between those according to the preferred embodiment (indicated by dotted line). Accordingly, the accuracy of the discrimination between the human and the object (e.g., erection object) fixed on the ground can be further improved.

Furthermore, in the preferred embodiment, the load detection unit 1 is arranged between the upper bumper reinforce member 8 and the side member 6. However, the load detection unit 1 can be also disposed at other position. Moreover, the load sensor 1 can be also provided with a shape other than that described in the preferred embodiment.

The load sensor 1 (serving as load detection unit) can be also substituted by other sensor, for example, a mat-typed pressure-sensitive sensor which has multiple sensor cells and is arranged between the upper bumper reinforce member 8 and the upper bumper absorber 9.

In the preferred embodiment, the lower bumper absorber 11 is supported by the side members 6 (first support unit) through the brackets 7 and the lower bumper reinforce member 10. However, the lower bumper absorber 11 can be also supported by members different from the side members 6 on condition that the load exerted at the lower bumper absorber 11 is not transmitted to the load detection unit 1. For example, the lower bumper absorber 11 can be also supported by a radiator support member (second support unit) for supporting a radiator (not shown) of the vehicle.

Moreover, in the preferred embodiment, the vehicle velocity sensor 2 is provided to detect the vehicle velocity. However, the vehicle velocity sensor 2 can be also omitted. In this case, the obstacle colliding with the vehicle is sort-discriminated based on the detected load only.

Such changes and modifications are to be understood as being in the scope of the present invention as defined by the appended claims.

What is claimed is:

1. An obstacle discrimination device for a vehicle, the obstacle discrimination device comprising:
an upper bumper absorber which is arranged at an upper portion in a bumper of the vehicle to absorb collision energy;
a lower bumper absorber which is arranged at a lower portion in the bumper to absorb collision energy;
a load detection unit for detecting a load exerted to the vehicle due to a collision between an obstacle and the bumper; and
a control unit for sort-discriminating the obstacle based on the load detected by the load detection unit, wherein:
the upper bumper absorber is connected with a first support unit of the vehicle through the load detection unit; and
the lower bumper absorber is connected with one of the first support unit and a second support unit of the vehicle without through the load detection unit, the second support unit being different from the first support unit.

2. The obstacle discrimination device according to claim 1, wherein:
the first support unit is constructed of two side members of the vehicle, the side members being respectively arranged at a left portion and a right portion of the vehicle and extending in a vehicle front-rear direction; and
the lower bumper absorber is connected with the first support unit.

3. The obstacle discrimination device according to claim 1, wherein:
the first support unit is constructed of two side members of the vehicle, the side members being respectively arranged at a left portion and a right portion of the vehicle and extending in a vehicle front-rear direction; and
the lower bumper absorber is connected with the second support unit, which is constructed of a radiator support member for supporting a radiator of the vehicle.

4. The obstacle discrimination device according to claim 1, wherein at least a part of the lower bumper absorber is arranged at a vehicle front side of the upper bumper absorber.

5. The obstacle discrimination device according to claim 1, wherein the load detection unit is constructed of a plurality of load sensors.

6. The obstacle discrimination device according to claim 5, wherein the load sensor is a strain-typed load sensor.

7. The obstacle discrimination device according to claim 6, wherein
the strain-typed load sensor is arranged between a rear end surface of a bumper reinforce member of the vehicle and a front end surface of the first support unit, the bumper reinforce member being disposed at the upper portion in the bumper and positioned at a vehicle rear side of the upper bumper absorber.

8. The obstacle discrimination device according to claim 1, wherein the load detection unit is constructed of a plurality of mat-typed pressure-sensitive sensors, each of which has a plurality of sensor cells.

9. The obstacle discrimination device according to claim 8, wherein the mat-typed pressure-sensitive sensor is arranged between a front end surface of a bumper reinforce member of the vehicle and a rear end surface of the upper bumper absorber, the bumper reinforce member being disposed at the upper portion in the bumper and positioned at a vehicle rear side of the upper bumper absorber.

10. The obstacle discrimination device according to claim 1, further comprising
a vehicle velocity detection unit for detecting a velocity of the vehicle, wherein
the control unit sort-discriminates the obstacle colliding with the bumper based on a mass of the obstacle, the mass being calculated according to the load detected by the load detection unit and the vehicle velocity detected by the vehicle velocity detection unit.

11. The obstacle discrimination device according to claim 1, wherein the vehicle velocity detection unit is constructed of at least one velocity sensor.

12. The obstacle discrimination device according to claim 1, wherein
the control unit actuates a pedestrian protection device of the vehicle, when it is determined that the obstacle colliding with the vehicle is a pedestrian.

13. The obstacle discrimination device according to claim 1, wherein the control unit is a signal process circuit.
